(19) United States
(12) Patent Application Publication
(10) Pub. No.: US 2026/0098589 A1
(43) Pub. Date: Apr. 9, 2026

(54) PRESSURE RELIEF VALVE

(71) Applicant: AISAN KOGYO KABUSHIKI KAISHA, Obu-shi (JP)

(72) Inventors: Yasuhiro TSUZUKI, Chita-gun (JP); Shinji MURAI, Obu-shi (JP); Keiji NAKAYA, Nisshin-shi (JP)

(73) Assignee: AISAN KOGYO KABUSHIKI KAISHA, Obu-shi (JP)

(21) Appl. No.: 19/338,212

(22) Filed: Sep. 24, 2025

(30) Foreign Application Priority Data
Oct. 7, 2024 (JP) 2024-175732

(51) Int. Cl. F16K 17/04

(52) U.S. Cl. CPC F16K 17/0413

(57) ABSTRACT

A pressure relief valve includes a closure member capable of moving to open and close a fluid passage, and a coil spring biasing the closure member in a closing direction. The closure member has a load-receiving surface where the coil spring is seated, a guide wall surface extending from the load-receiving surface in an axial direction of the coil spring, and a recess portion formed in the load-receiving surface at a corner between the load-receiving surface and the guide wall surface.

### CROSS-REFERENCE TO RELATED APPLICATIONS

This application claims priority to Japanese patent application serial number 2024-175732 filed Oct. 7, 2024, which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to pressure relief valves.

Some sealed systems such as sealed tanks are equipped with a valve for pressure relief. For example, one pressure relief valve is disposed in a vent passage connecting the fuel tank of a vehicle to the atmosphere for controlling the internal pressure of the fuel tank. This pressure relief valve comprises two closure members. When the internal pressure of the fuel tank reaches a predetermined negative pressure, one closure member opens, and when the internal pressure reaches a predetermined positive pressure, the other closure member opens, thereby maintaining the internal pressure within an appropriate range.

Generally, most pressure relief valves are required to meet stringent performance standards for preventing leakage in the low-pressure range while ensuring reliable opening in the high-pressure range. To meet this requirement, the coil spring of the pressure relief valve is required to remain stably seated at the specified location and to apply a constant force to the closure member at all times. Therefore, there is a need for an improved pressure relief valve that can stably mount the coil spring.

### SUMMARY

In one aspect of this disclosure, a pressure relief valve includes a closure member capable of moving to open and close a fluid passage, and a coil spring biasing the closure member in a closing direction. The closure member has a load-receiving surface where the coil spring is seated, a guide wall surface extending from the load-receiving surface in an axial direction of the coil spring, and a recess portion formed in the load-receiving surface at a corner between the load-receiving surface and the guide wall surface.

### BRIEF DESCRIPTION OF THE DRAWINGS

FIG. 1 is a cross-sectional view of the pressure relief valve in a closed state.

FIG. 2 is a cross-sectional view of the pressure relief valve of FIG. 1, performing positive pressure relief of a fuel tank.

FIG. 3 is a cross-sectional view of the pressure relief valve of FIG. 1, performing negative pressure relief of the fuel tank.

FIG. 4 is a plan view of a closure member of the pressure relief valve of FIG. 1 for positive pressure relief.

FIG. 5 is a cross-sectional view of the closure member of FIG. 4, along the V-V line.

FIG. 6 is a perspective view showing a projected rim and a recess portion that are formed on the closure member of FIG. 4.

FIG. 7 is a perspective view of a coil spring with its ends ground flat, viewed from the lower diagonal direction.

FIG. 8 is an enlarged cross-sectional view of the projected rim and the recess portion of FIG. 6.

FIG. 9 is a cross-sectional view of a curved surface formed at the corner and the coil spring rising up onto the curved surface when no recess portion is formed.

FIG. 10 is a schematic view of a fuel tank system having the pressure relief valve of FIG. 1.

### DETAILED DESCRIPTION

Some embodiments of the present disclosure are described below in reference to the drawings.

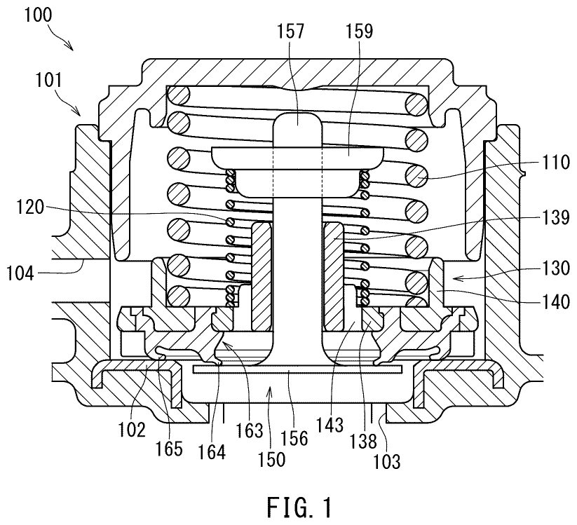

FIG. 1 shows an embodiment of a pressure relief valve 100 having a bi-directional pressure relief function. The pressure relief valve 100 has one port connected to a tank (not shown) and the other port connected to the atmosphere. The pressure relief valve 100 is configured to perform positive pressure relief and negative pressure relief of the tank.

The pressure relief valve 100 includes a housing 101 defining a valve chamber therein. The housing 101 has a tank-side port 103 and an atmospheric side port 104. The valve chamber, the tank-side port 103, and the atmospheric side port 104 form a fluid passage to allow fluid to flow through the pressure relief valve 100. The housing 101 may be constructed from two separate components. The pressure relief valve 100 includes a first closure member 130 for positive pressure relief and a second closure member 150 for negative pressure relief. The first closure member 130 and the second closure member 150 are arranged within the valve chamber to be axially movable in an independent manner. The first closure member 130 is generally located outside the second closure member 150.

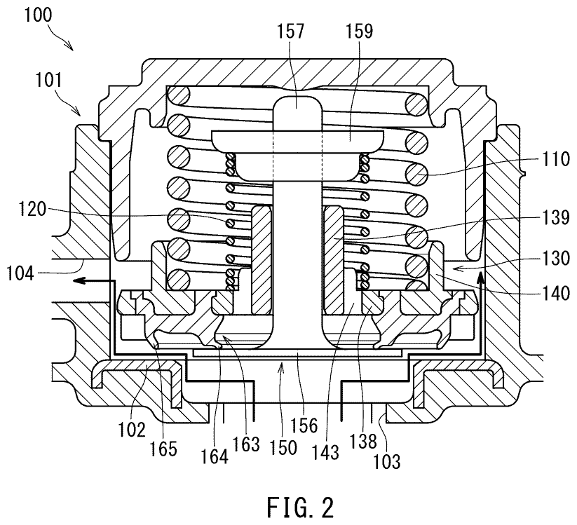

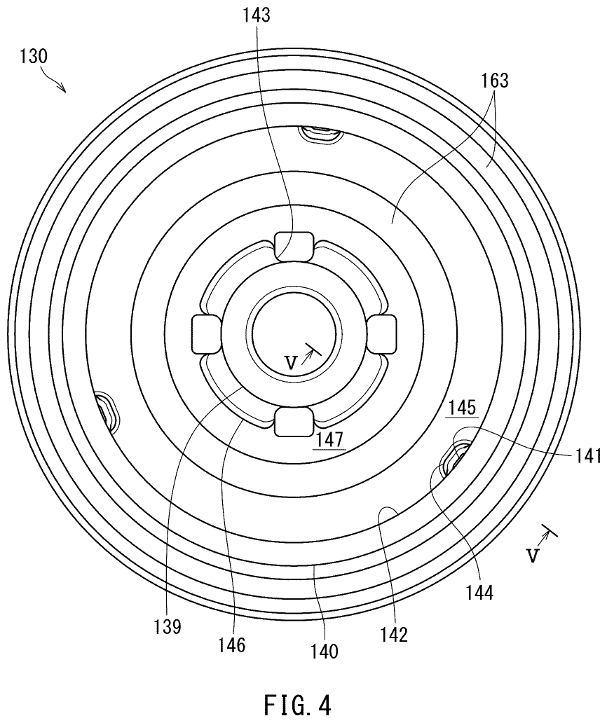

As shown in FIGS. 1 and 2, the first closure member 130 for positive pressure relief has a plate part 138 with a plurality of through holes 143 (e.g., four shown in FIG. 4) around its center. The housing 101 includes a metallic annular valve seat 102 that is located around the tank-side port 103. An outer periphery of the plate part 138 faces the valve seat 102. When the first closure member 130 moves upward together with the second closure member 150 and separates from the valve seat 102, the fluid passage is opened (see FIG. 2). When the first closure member 130 moves downward and comes into contact with the valve seat 102, the fluid passage is closed (see FIG. 1).

The first closure member 130 is biased by a coil spring 110 in the closing direction, i.e. downward, with respect to the housing 101. The first closure member 130 has an outer cylindrical part 140 that extends upward from the plate part 138. The coil spring 110 is located inside the outer cylindrical part 140. The coil spring 110 is axially held between the plate portion 138 and the housing 101.

The first closure member 130 includes an annular sealing member 163 that is made from an elastic material such as rubber or an elastomer. The sealing member 163 is securely attached to the underside of the plate part 138 using methods like insert molding or adhesive bonding. The sealing member 163 has an annular sealing part 165 that protrudes downward toward the valve seat 102. When the first closure member 130 is in its closed position, the biasing force of the coil spring 110 presses the annular sealing part 165 against the valve seat 102, sealing a gap tightly between the first closure member 130 and the valve seat 102.

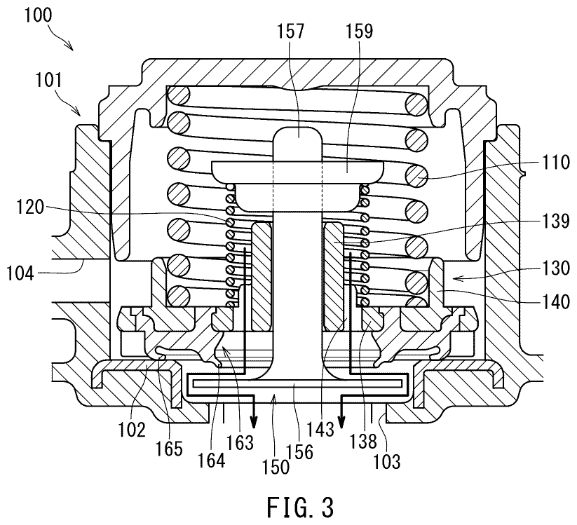

As shown in FIGS. 1 and 3, the second closure member 150 for negative pressure relief includes a plate part 156 and a shaft part 157 that axially extends from the plate part 156. The shaft part 157 is slidably fitted into an inner cylindrica part 139 that axially extends from an inner periphery of the plate part 138. The inner periphery of the plate part 138 of the outer first closure member 130 faces the plate part 156 of the second closure member 150 and acts as a valve seat for the second closure member 150. As shown in FIG. 3, when the second closure member 150 moves downward and separates from the first closure member 130, the fluid passage, including the through holes 143, is opened. As shown in FIG. 1, when the second closure member 150 moves upward and makes contact with the first closure member 130, the fluid passage is closed.

The inner second closure member 150 is biased in the closing direction, i.e., upward, with respect to the outer first closure member 130 by a second coil spring 120. The second coil spring 120 is located inside the coil spring 110 and positioned at the outside of the inner cylindrical part 139 of the first closure member 130. Specifically, the second coil spring 120 is held between the plate part 138 of the first closure member 130 and a flange-shaped spring receiving part 159 that is provided around the shaft part 157.

The sealing member 163 of the first closure member 130 includes a second annular sealing part 164 that protrudes toward the plate part 156 of the second closure member 150 on the inner side of the annular sealing part 165. When the second closure member 150 is in the closed position, the plate part 156 is pressed against the second annular sealing part 164 by the biasing force of the second coil spring 120, thereby sealing the gap between the first closure member 130 and the second closure member 150.

Next, operations of the pressure relief valve 100 will be described. When the internal pressure on the tank-side becomes too high relative to the pressure on the open side, the first closure member 130 is forced upward, moving against the biasing force of the coil spring 110. As shown in FIG. 2, this action causes the annular sealing part 165 to lift away from the valve seat 102, opening the fluid passage and allowing the excess positive pressure to escape from the tank until the first closure member 130 returns to its closed position. Conversely, when the internal pressure on the tank-side becomes too low, the second closure member 150 moves downward against the biasing force of the second coil spring 120. As shown in FIG. 3, this separates the plate part 156 of the second closure member 150 from the second annular sealing part 164, opening the fluid passage and relieving the negative pressure from the tank until the second closure member 150 returns to its closed position.

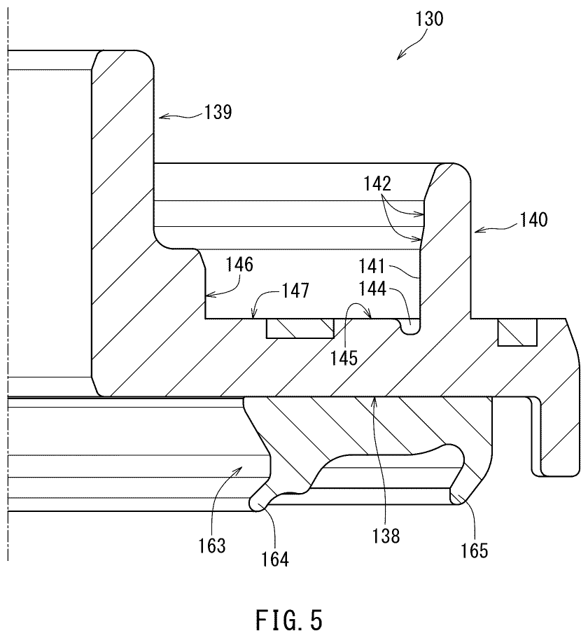

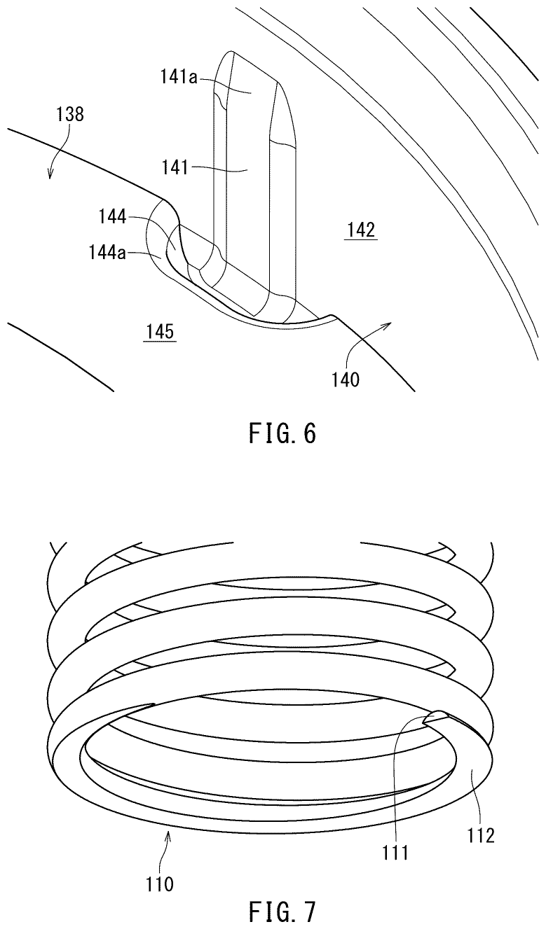

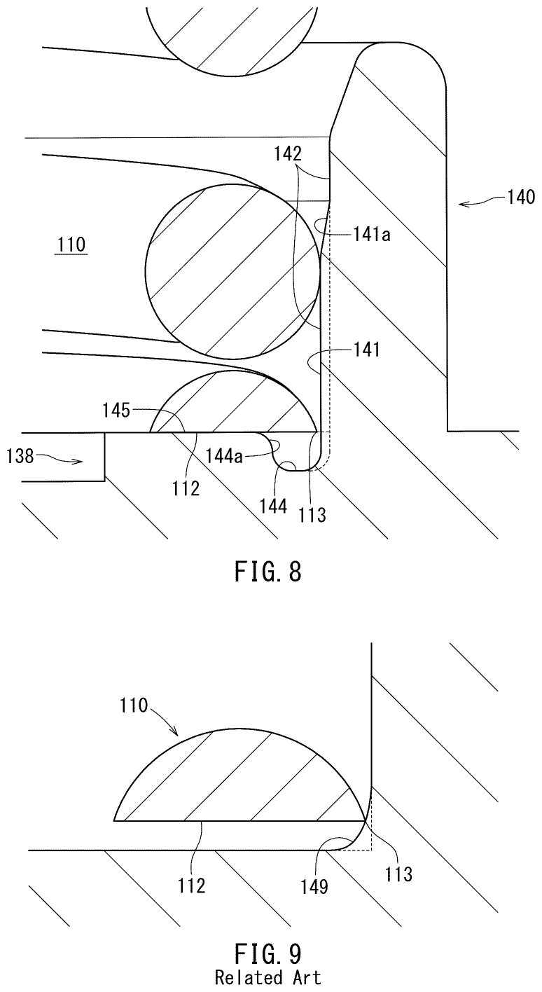

As shown in FIGS. 6 and 8, the coil spring 110 is located inside the outer cylindrical part 140 extending from the plate part 138 of the first closure member 130 and is held between the plate part 138 and the housing 101. An upper surface of the plate part 138 acts as a load-receiving surface 145 on which the coil spring 110 is seated. As shown in FIG. 7, the end portion of the coil spring 110 adjacent to the load receiving surface 145 is ground or machined to form a flat surface 112 perpendicular to the axis of the coil spring 110. The cross-sectional area of the wire of the coil spring 110 gradually decreases toward a tip end 111 and becomes, for example, smaller than a semicircular shape at the tip end 111.

As shown in FIGS. 4 to 6 and 8, the inner wall surface of the outer cylindrical part 140 has a guide wall surface 142 that axially extends from the load-receiving surface 145. The guide wall surface 142 includes at least one, and in some cases, three or more projected rims 141 that extend along the axial direction of the coil spring 110. The projected rims 141 restricts the movement of the coil spring 110 in the direction perpendicular to its axis during use of the pressure relief valve 100, preventing variations in the biasing force applied to the first closure member 130. When the guide wall surface 142 has three or more projected rims 141, the coil spring 110 can be aligned more effectively. The three or more projected rims 141 are specifically positioned to avoid diametrically opposite locations. For example, the three projected rims 141 may be located at 120-degree intervals. This configuration makes it easier to press-fit the coil spring 110 into the outer cylindrical part 140. The outer cylindrical part 140 has a clearance space at the position diametrically opposite to each projected rim 141 to accommodate the clamping force, thereby allowing for easy assembly. Accordingly, the fit tolerance between the coil spring 110 and the outer cylindrical part 140 can be set as intermediate fit. In another embodiment (not shown), the outer cylindrical part 140 may have five or more odd-numbered projected rims 141 that are arranged to avoid diametrically opposite positions, e.g., at regular intervals.

The load-receiving surface 145 of the plate part 138 and the guide wall surface 142 of the outer cylindrical part 140 form a corner therebetween. At this corner, the load-receiving surface 145 has at least one recess portion 144. In one embodiment shown in FIG. 4, the recess portions 144 are located at the same circumferential positions as the projected rims 141. Each recess portion 144 may be a curved groove that surrounds its corresponding projected rim 141 at the load-receiving surface 145. By designing the first closure member 130 with the corner pre-cut to remove excess material, i.e., forming the recess portions 144, it is possible to avoid forming a curved surface 149 as shown in FIG. 9 at the corner during the forming of the first closure member 130. Even if the curved surface 149 is provided at the corner, an outer edge 113 of the lower end part of the coil spring 110 (e.g., having a semicircular cross-section) rises up onto the curved surface 149, thereby increasing variations in the biasing force applied to the first closure member 130. Accordingly, the formation of the recess portion 144 enables the suppression of variations in the biasing force applied to the first closure member 130 as shown in FIGS. 5 and 8. Additionally, the sealing performance of the sealing member 163 is improved.

As shown in FIG. 6, each recess portion 144 is connected to the load-receiving surface 145 by a curved surface 144a to prevent the formation of a sharp edge therebetween when forming the recess portion 144. In addition, each recess portion 144 is linearly connected to the guide wall surface 142, including a surface of the projected rim 141, in the axial direction of the outer cylindrical part 140 to prevent the formation of unnecessary steps at the corner when forming the recess portion 144. The axial length of the projected rim 141 may be configured to a value that does not influence the expansion and contraction of the effective winding section of the coil spring 110. An upper end of the projected rim 141 may be shaped as an inclined surface 141a where the projection length of the projected rim 141 becomes smaller toward the top. This facilitates the assembly of the coil spring 110.

In another embodiment (not shown), an annular groove may be formed throughout the entire circumference of the circular corner between the load-receiving surface 145 and the guide wall surface 142.

In another embodiment (not shown), if the end of the second coil spring 120 has a flat surface formed by griding or the like, the same features described above can be applied to the corner where the second coil spring 120 is positioned. In other words, similar projected rim can be formed on an outer guide wall surface 146 (see FIG. 5) of the inner cylindrical part 139 of the first closure member 130, and similar recessed portion can be formed on a load-receiving surface 147 of the plate part 138 of the first closure member 130, on which the coil spring 120 is seated.

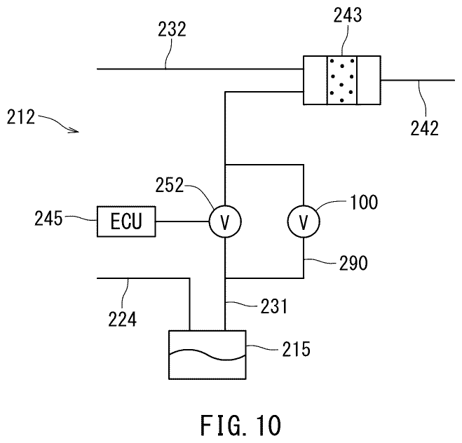

As shown in FIG. 10, in one embodiment, the pressure relief valve 100 may be used in a fuel tank system 212 of a vehicle such as an automobile. The fuel tank system 212 includes a fuel tank 215 for storing liquid fuel, such as gasoline, to be supplied to an engine. The pressure relief valve 100 performs both the positive pressure relief and negative pressure relief functions of the fuel tank 215. The fuel in the fuel tank 215 is drawn out by a fuel pump (not shown), supplied through a supply passage 224, and injected into the intake passage of the engine by injectors (not shown).

The fuel tank system 212 includes a canister 243 that is filled with an adsorbent such as activated carbon for trapping evaporated fuel (fuel vapor) generated in the fuel tank 215. A gas phase in the fuel tank 215 is connected the canister 243 via a vapor passage 231. The canister 243 is open to the atmosphere via an atmospheric passage 242. When the internal pressure of the fuel tank 215 becomes higher, the fuel vapor flows through the vapor passage 231 and then is adsorbed in the canister 243.

A tank closing valve 252 is located in the vapor passage 231. The tank closing valve 252 closes the vapor passage 231 as necessary to prevent the fuel vapor from flowing from the fuel tank 215 into the canister 243. When the fuel inlet (the open end of the inlet pipe) is closed by the lid and the vapor passage 231 is blocked by the tank closing valve 252, the fuel tank 215 becomes sealed, thereby suppressing the amount of the fuel vapor trapped in the canister 243.

Although not shown, the tank closing valve 252 is configured such that when the closure member separates from the valve seat formed on the housing, the vapor passage 231 is opened, and when the closure member comes into contact with the valve seat, the vapor passage 231 is closed. The tank closing valve 252 may include a motor and be configured such that the rotation of the motor is converted into linear movement of the closure member by the screw action of a threaded shaft and a threaded mating component. The tank closing valve 252 is controlled by a control unit 245, such as an electronic control unit, that is electrically connected to the motor.

The tank closing valve 252 may be configured such that the closure member is supported by one end of a coil spring, and the position of the other end of the coil spring is changed by the motor to adjust the sealing pressure, as described in JP 2018-105307A. Specifically, when the internal pressure of the fuel tank 215, more precisely the relative pressure of the tank-side with respect to the pressure of the canister-side, is lower than the sealing pressure, the closure member is held in the closed position by the biasing force of the coil spring. When the internal pressure of the fuel tank 215 increases and exceeds the sealing pressure, the closure member moves against the biasing force of the coil spring, thereby opening the vapor passage 231. When the sealing pressure is set to zero, the tank closing valve 252 is forcibly maintained in the open state.

A purge passage 232 connects the canister 243 to the intake passage downstream of the throttle valve. During vehicle operation or idling, the tank closing valve 252 can be either closed at a low sealing pressure or kept open. This configuration allows the canister 243 to be purged as needed. Specifically, the purge valve disposed in the purge passage is opened to apply the intake vacuum of the engine to the interior of the canister 243. As a result, air is drawn into the canister 243 through the atmospheric passage 242 from the outside, and fuel molecules adsorbed in the canister 243 are desorbed. The desorbed fuel molecules are drawn into the intake passage along with the air and eventually burned in the engine. During engine shutdown, the tank closing valve 252 can be switched to a high sealing pressure to suppress the flow of the fuel vapor into the canister 243.

The fuel tank system 212 includes a bypass passage 290 that goes around the tank closing valve 252. The pressure relief valve 100 is disposed in the bypass passage 290 to relieve excess positive and negative pressure within the sealed fuel tank 215. Accordingly, the tank-side end of the bypass passage 290 is connected to the vapor passage 231 upstream of the tank closing valve 252, e.g., the inlet passage within the housing of the tank closing valve 252. Similarly, the canister-side end of the bypass passage 290 is connected to the vapor passage 231 downstream of the tank closing valve 252, e.g., the outlet passage within the housing of the tank closing valve 252.

It is possible for the tank closing valve 252 to malfunction and be unable to open. If this happens and the internal pressure in the fuel tank 215 gets too high relative to the pressure on the canister-side, the first closure member 130 of the pressure relief valve 100 will move away from the valve seat 102 to open the bypass passage 290, relieving the positive pressure from the fuel tank 215 until the first closure member 130 returns to its closed position. In a case where the sealing pressure is set for the tank closing valve 252 in the closed position, the opening pressure of the pressure relief valve 100 for positive pressure relief may be set to a value that is equal to or greater than the maximum sealing pressure of the tank closing valve 252.

The tank closing valve 252 cannot relieve negative pressure from the fuel tank 215 unless the tank closing valve 252 is held in the open position. When the internal pressure of the fuel tank 215 decreases excessively, the second closure member 150 of the pressure relief valve 100 moves away from the second annular sealing part 164 to open the bypass passage 290. This can relieve the negative pressure from the fuel tank 215 until the second closure member 150 returns to the closed position.

The present disclosure is not limited to the embodiment described above, but can be implemented in various other forms.

The present disclosure includes various aspects as follows. In a first aspect of this disclosure, a pressure relief valve includes a closure member capable of moving to open and close a fluid passage, and a coil spring biasing the closure member in a closing direction. The closure member has a load-receiving surface where the coil spring is seated, a guide wall surface extending from the load-receiving surface in an axial direction of the coil spring, and a recess portion formed in the load-receiving surface at a corner between the load-receiving surface and the guide wall surface. By designing the closure member with the corner pre-cut to remove excess material, it is possible to avoid the formation of a curved surface on the corner during the forming of the closure member. Accordingly, variations in the biasing force on the closure member caused by the coil spring riding on the curved surface can be suppressed.

In a second aspect of this disclosure, the recess portion is connected to the load-receiving surface by a curved surface. Accordingly, it is possible to suppress the formation of a sharp edge on the load-receiving surface when forming the recess portion.

In a third aspect of this disclosure, the recess portion is linearly connected to the guide wall surface. Accordingly, it is possible to avoid the formation of an unnecessary step at the corner when forming the recess portion.

In a fourth aspect of this disclosure, the guide wall surface has a projected rim extending in the axial direction. This prevents the coil spring from moving in a direction perpendicular to the axis thereof during use of the pressure relief valve to reduce variations in the biasing force applied to the closure member.

In a fifth aspect of this disclosure, the recess portion is located in a position corresponding to the projected rim.

In a sixth aspect of this disclosure, the closure member comprises at least three projected rims extending in the axial direction. Accordingly, alignment of the coil spring can be performed effectively to suppress variations in the biasing force on the closure member.

In a seventh aspect of this disclosure, the closure member comprises an odd number of the projected rims. The projected rims are positioned to avoid diametrically opposite locations. Accordingly, even when it is necessary to press-fit the coil spring into the interior space formed by the guide wall surface, there is a clearance space at the position diametrically opposite to each projected rim to accommodate the clamping force, thereby allowing for easy assembly.

What is claimed is:

1. A pressure relief valve, comprising:
a closure member configured to move to open and close a fluid passage; and
a coil spring biasing the closure member in a closing direction;
wherein the closure member comprises a load-receiving surface where the coil spring sits, a guide wall surface extending from the load-receiving surface along an axial direction of the coil spring, and a recess portion positioned in the load-receiving surface at a corner between the load-receiving surface and the guide wall surface.

2. The pressure relief valve of claim 1, wherein the recess portion is connected to the load-receiving surface by a curved surface.

3. The pressure relief valve of claim 1, wherein the recess portion is linearly connected to the guide wall surface.

4. The pressure relief valve of claim 1, wherein the guide wall surface has a projected rim that extends along the axial direction.

5. The pressure relief valve of claim 4, wherein the recess portion is positioned to correspond with the projected rim.

6. The pressure relief valve of claim 4, wherein the closure member comprises at least three projected rims that extend along the axial direction.

7. The pressure relief valve of claim 6, wherein:
the closure member comprises an odd number of the at least three projected rims; and
the at least three projected rims are positioned to avoid diametrically opposite locations.
